(19) United States
(12) Patent Application Publication
(10) Pub. No.: US 2026/0237947 A1
(43) Pub. Date: Aug. 13, 2026

(54) COAXIAL CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Risa ITO, Mie (JP)

(21) Appl. No.: 19/470,813

(22) PCT Filed: Mar. 22, 2024
(86) PCT No.: PCT/JP2024/011296

§ 371 Date: Sep. 30, 2025

(30) Foreign Application Priority Data
Apr. 5, 2023 (JP) 2023-061296

(51) Int. Cl. H01R 24/40; H01R 103/00

(52) U.S. Cl. CPC H01R 24/40; H01R 2103/00

(57) ABSTRACT

The purpose of the present invention is to provide a coaxial connector in which an interval between an inner conductor and an outer conductor can be easily adjusted. The present invention provides a coaxial connector in which a pin-like counterpart inner conductor is inserted and connected to an inner conductor, said coaxial connector comprising an inner conductor that has a tubular base part and a plurality of elastic pieces that extend from one end of the tubular base part, an insulator that surrounds the inner conductor, and an outer conductor that surrounds the insulator. The plurality of elastic pieces each have an elastic piece body that extends from the one end of the tubular base part toward one side of the tubular base part in the axial direction and a contact part that protrudes inward from the elastic piece body. The base end of the elastic piece body has an elastic support part that elastically deforms so that the leading end of the elastic piece body is displaced outward in response to outward displacement of the contact part.

### TECHNICAL FIELD

The present disclosure relates to a coaxial connector.

### BACKGROUND

Patent Document 1 discloses a coaxial connector provided with a lower contact, to which a connection pin is inserted and connected. In a technique disclosed in Patent Document 1, the lower contact is surrounded by a lower insulator and the outer periphery of the lower insulator is surrounded by an electrically conductive external shell.

### PRIOR ART DOCUMENT

### Patent Document

Patent Document 1: JP 2020-092313 A

### SUMMARY OF THE INVENTION

### Problems to be Solved

In the coaxial connector, an interval between the lower contact and the external shell possibly affects the communication performance of the coaxial connector. Thus, it is desired to make the interval between the lower contact and the external shell adjustable with the connection pin inserted in the lower contact.

Accordingly, the present disclosure aims to provide a coaxial connector in which an interval between an inner conductor and an outer conductor is easily adjusted.

### Means to Solve the Problem

The present disclosure is directed to a coaxial connector with an inner conductor, a pin-like mating inner conductor being inserted and connected to the inner conductor, the inner conductor including a tubular base portion and a plurality of resilient pieces extending from one end of the tubular base portion, an insulator surrounding the inner conductor, and an outer conductor surrounding the insulator, each of the plurality of resilient pieces including a resilient piece body extending from one end of the tubular base portion toward one side in an axial direction of the tubular base portion and a contact portion projecting inward from the resilient piece body, and a base end of the resilient piece body including a resilient supporting portion to be resiliently deformed to displace a tip of the resilient piece body outward according to an outward displacement of the contact portion.

### Effect of the Invention

According to the present disclosure, it is possible to provide a coaxial connector in which an interval between an inner conductor and an outer conductor is easily adjusted.

### BRIEF DESCRIPTION OF THE DRAWINGS

FIG. 1 is a perspective view showing a device provided with a relay coaxial connector according to an embodiment.

FIG. 2 is a section along II-II of FIG. 1.

FIG. 3 is an exploded perspective view showing the relay coaxial connector.

FIG. 4 is a diagram showing a state before an external connection coaxial connector is connected to the relay coaxial connector.

FIG. 5 is a partial enlarged section of FIG. 4.

FIG. 6 is a section showing a state where the external connection coaxial connector is connected to the relay coaxial connector.

FIG. 7 is a perspective view showing a modification of a movable side inner conductor.

### DETAILED DESCRIPTION TO EXECUTE THE INVENTION

### Description of Embodiments of Present Disclosure

First, embodiments of the present disclosure are listed and described.

The coaxial connector of the present disclosure is as follows.

(1) The coaxial connector of the present disclosure is provided with an inner conductor, a pin-like mating inner conductor being inserted and connected to the inner conductor, the inner conductor including a tubular base portion and a plurality of resilient pieces extending from one end of the tubular base portion, an insulator surrounding the inner conductor, and an outer conductor surrounding the insulator, each of the plurality of resilient pieces including a resilient piece body extending from one end of the tubular base portion toward one side in an axial direction of the tubular base portion and a contact portion projecting inward from the resilient piece body, and a base end of the resilient piece body including a resilient supporting portion to be resiliently deformed to displace a tip of the resilient piece body outward according to an outward displacement of the contact portion.

According to this coaxial connector, if the mating inner conductor is inserted and connected to the inner conductor, the mating inner conductor contacts the contact portion of each of the plurality of resilient pieces. In this way, if each contact portion is displaced outward, the resilient supporting portion located on the base end of the resilient piece body is resiliently deformed and the tip of the resilient piece body is displaced outward. Thus, the tip of the resilient piece body can be displaced outward and an interval between the inner conductor and the outer conductor is easily adjusted according to a thickness of the mating inner conductor and a projecting amount of the contact portion.

(2) In the coaxial connector of (1), the contact portion may be a resilient contact piece folded from the tip of the resilient piece body toward the base end of the resilient piece body via a folded portion.

In this way, the resilient piece body and the contact portion can be easily formed by folding.

(3) In the coaxial connector of (2), a tip of the resilient contact piece may be separated from the resilient piece body.

In this way, a signal transmission path from a contact part of the resilient contact piece and the mating inner conductor by way of the folded portion and the resilient piece body is configured. Thus, a desired characteristic impedance is obtained by noise design based on the resilient piece body.

(4) In the coaxial connector of (3), the resilient supporting portion may have resilience to keep the tip of the resilient contact piece in a state separated from the resilient piece body with the mating inner conductor inserted and connected to the inner conductor.

In this way, a desired characteristic impedance designed based on the resilient piece body is obtained also with the mating inner conductor inserted and connected to the inner conductor.

(5) In the coaxial connector of any one of (2) to (4), a resilient deformation amount of the resilient supporting portion may be larger than a resilient deformation amount of the folded portion with the mating inner conductor inserted and connected to the inner conductor.

In this way, the tip of the resilient piece body can be more largely displaced outward and the interval between the inner conductor and the outer conductor is easily adjusted according to the thickness of the mating inner conductor and the projecting amount of the contact portion.

(6) In the coaxial connector of any one of (2) to (5), a distance between an inner contact part of the resilient contact piece with the mating inner conductor and the resilient supporting portion may be greater than a distance between the inner contact part and the folded portion.

In this case, a larger moment acts on the resilient supporting portion than on the folded portion and the resilient supporting portion is largely resiliently deformed by a displacement of the inner contact part. Thus, the tip of the resilient piece body can be more largely displaced outward and the interval between the inner conductor and the outer conductor is easily adjusted according to the thickness of the mating inner conductor and the projecting amount of the contact portion.

(7) In the coaxial connector of any one of (2) to (6), the folded portion may be formed with a rib for suppressing resilient deformation of the folded portion.

In this way, the folded portion can be made less likely to be resiliently deformed.

(8) In the coaxial connector of any one of (1) to (7), the outer conductor may include an inclined portion inclined outward toward the tip of the resilient piece body between the resilient supporting portion and the tip of the resilient piece body along the axial direction of the tubular base portion.

Wit the tip of the resilient piece body displaced outward, the resilient piece body is thought to be inclined outward toward the tip. In this case, a change of an interval between the resilient piece body and the inclined portion of the outer conductor can be suppressed and noise design is facilitated.

(9) In the coaxial connector of any one of (1) to (8), an inner contact part of the contact portion with the mating inner conductor and an outer contact part of the outer conductor with a mating outer conductor may be set at the same position in the axial direction of the tubular base portion.

In this case, even if the coaxial connector is inclined with respect to the mating coaxial connector, the inner contact part and the outer contact part are easily arranged around the same axis. In this way, even if the coaxial connector is inclined with respect to the mating coaxial connector, the degradation of communication performance is suppressed.

### Details of Embodiment of Present Disclosure

A specific example of a coaxial connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a coaxial connector according to an embodiment is described. In this embodiment, an example in which the coaxial connector is a relay coaxial connector incorporated in a device is described. Note that it is not essential that the coaxial connector is incorporated in the device and is the relay coaxial connector. For example, the coaxial connector may be a connector to be mounted on a cable end part or a coaxial connector to be mounted on a board.

### Concerning Overall Configuration of Device

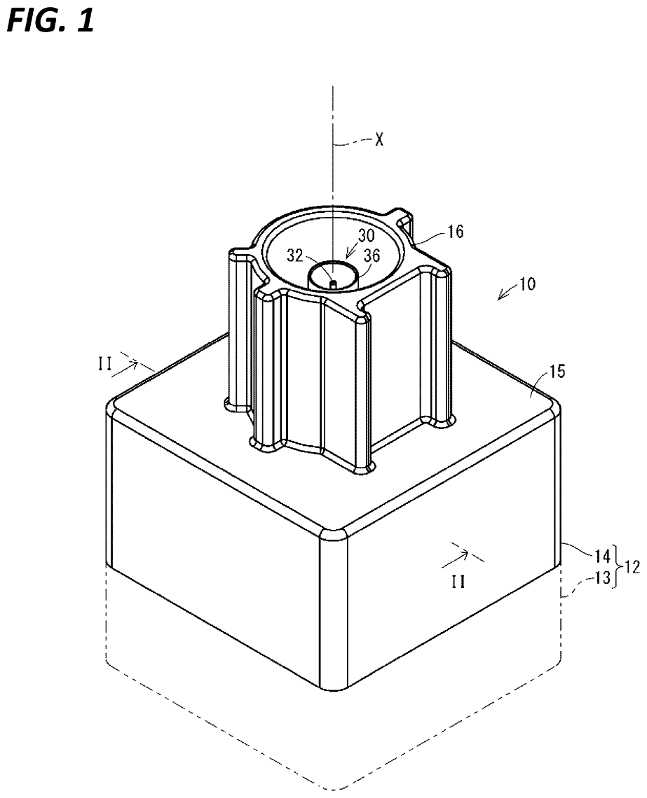

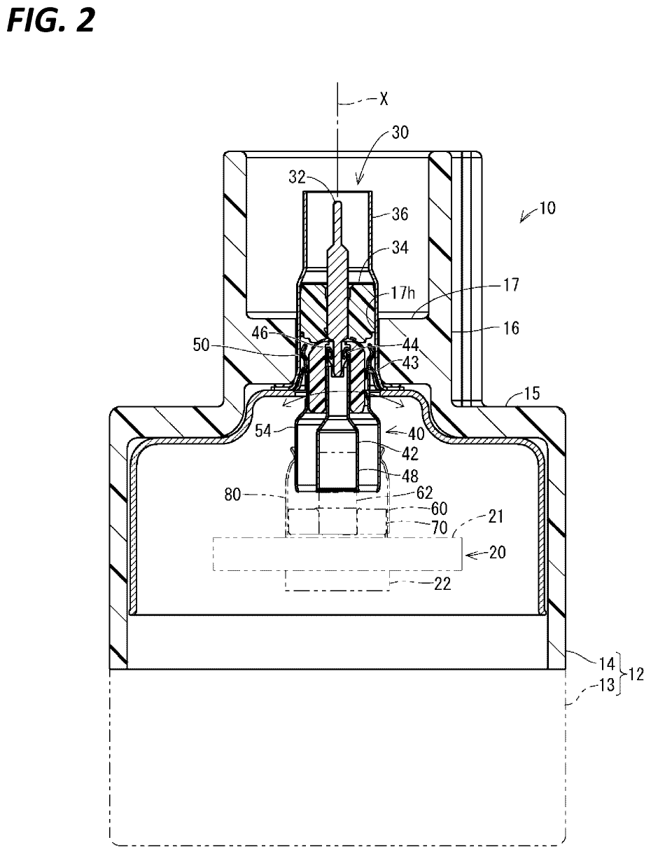

An example of a device 10 provided with a relay coaxial connector 40 is described. FIG. 1 is a perspective view showing the device 10 provided with the relay coaxial connector 40. FIG. 2 is a section along II-II of FIG. 1.

The device 10 is, for example, a camera device. The camera device is, for example, an in-vehicle device. The device 10 may not be a camera device.

The device 10 is provided with a case 12 and an electrical component 20. The electrical component 20 is accommodated in the case 12. The relay coaxial connector 40 is fixed to the electrical component 20.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes an external connection coaxial connector 30.

The external connection coaxial connector 30 is a coaxial connector for connecting the electrical component 20 and an external electrical component. For example, the external connection coaxial connector 30 is a coaxial connector, to which a cable connected to the external electrical component is connected. The cable connected to the external connection coaxial connector 30 is, for example, a coaxial cable.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16 (axial direction X). In this embodiment, the holding/partitioning portion 17 is formed in the intermediate part in the direction along the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

The external connection coaxial connector 30 is provided with an external connection inner conductor 32, an external connection insulator 34 and an external connection outer conductor 36.

The external connection inner conductor 32 is in the form of an elongated bar and made of an electrically conductive material such as metal. The external connection inner conductor 32 is an example of a pin-like mating inner conductor to be inserted and connected to a movable side inner conductor 42 to be described later. The external connection insulator 34 is formed of a dielectric such as resin and surrounds the external connection inner conductor 32. In this embodiment, the external connection insulator 34 is a dielectric. The external connection outer conductor 36 is made of an electrically conductive material such as metal. The external connection outer conductor 36 is formed into a tubular shape surrounding the external connection insulator 34. The external connection outer conductor 36 is an example of a mating outer conductor to be connected to a movable side outer conductor 54.

The electrical component 20 is, for example, a mounting board having an electronic component mounted thereon. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

A board side coaxial connector 60 is mounted and fixed on the circuit board 21. The board side coaxial connector 60 is located on a surface of the circuit board 21 opposite to the imaging element 22. The board side coaxial connector 60 projects from the circuit board 21 toward the external connection coaxial connector 30. The board side coaxial connector 60 is, for example, provided with a board side inner conductor 62, a board side insulator 70 and a board side outer conductor 80. The board side inner conductor 62 and the board side outer conductor 80 are, for example, connected to a circuit of the circuit board 21 by soldering or the like. The movable side inner conductor 42 to be described later is connected to the board side inner conductor 62. The board side insulator 70 surrounds the board side inner conductor 62. The board side outer conductor 80 surrounds the board side insulator 70. That is, the board side inner conductor 62, the board side insulator 70 and the board side outer conductor 80 are concentrically arranged in this order from a center toward an outer peripheral side.

The board side coaxial connector 60 and the external connection coaxial connector 30 are connected via the relay coaxial connector 40. The relay coaxial connector 40 is, for example, provided with the movable side inner conductor 42, a movable side insulator 50 and a movable side outer conductor 54. The movable side insulator 50 surrounds the movable side inner conductor 42. A dielectric can be grasped as one type of insulator, and the movable side insulator 50 may be a dielectric. The movable side outer conductor 54 surrounds the movable side insulator 50.

The movable side inner conductor 42 is an example of an inner conductor including a tubular base portion 43 and a plurality of resilient pieces 44. The movable side insulator 50 is an example of an insulator surrounding the movable side inner conductor 42 as the inner conductor. The movable side outer conductor 54 is an example of an outer conductor surrounding the movable side insulator 50 as the insulator.

The relay coaxial connector 40 is connected to the board side coaxial connector 60 in a state where the board side inner conductor 62 is inserted and connected to the movable side inner conductor 42 and the board side outer conductor 80 is externally fit and connected to the movable side outer conductor 54. In this state, the relay coaxial connector 40 projects further toward the external connection coaxial connector 30 from the board side coaxial connector 60. The external connection inner conductor 32 is inserted and connected to the movable side inner conductor 42 and the movable side outer conductor 54 is inserted and connected to the external connection outer conductor 36, whereby the relay coaxial connector 40 is connected to the external connection coaxial connector 30. In this way, the relay coaxial connector 40 relays and connects the board side coaxial connector 60 and the external connection coaxial connector 30.

In this way, by connecting a cable from outside to the external connection coaxial connector 30, an external electrical component as a connection destination of this cable and the electrical component 20 in the case 12 are electrically connected.

During an assembly operation of this device 10 or in a completed state of this device 10, there is a possibility that the board side coaxial connector 60 and the external connection coaxial connector 30 are shifted from positions facing each other on the same axis. In such a case, the movable side inner conductor 42 is possibly connected in a state inclined with respect to the board side inner conductor 62 and the external connection inner conductor 32. Further, the movable side outer conductor 54 is possibly connected in a state inclined with respect to the board side outer conductor 80 and the external connection outer conductor 36. That is, the relay coaxial connector 40 is possibly connected in a state inclined with respect to the board side coaxial connector 50 and the external connection coaxial connector. In this way, even if the board side coaxial connector 60 and the external connection coaxial connector 30 are shifted from the positions facing each other on the same axis during the assembly operation of this device 10 or in the completed state of this device 10, these position shifts are absorbed by the inclination of the relay coaxial connector 40 with respect to the board side coaxial connector 60 and the external connection coaxial connector.

### Concerning Relay Coaxial Connector

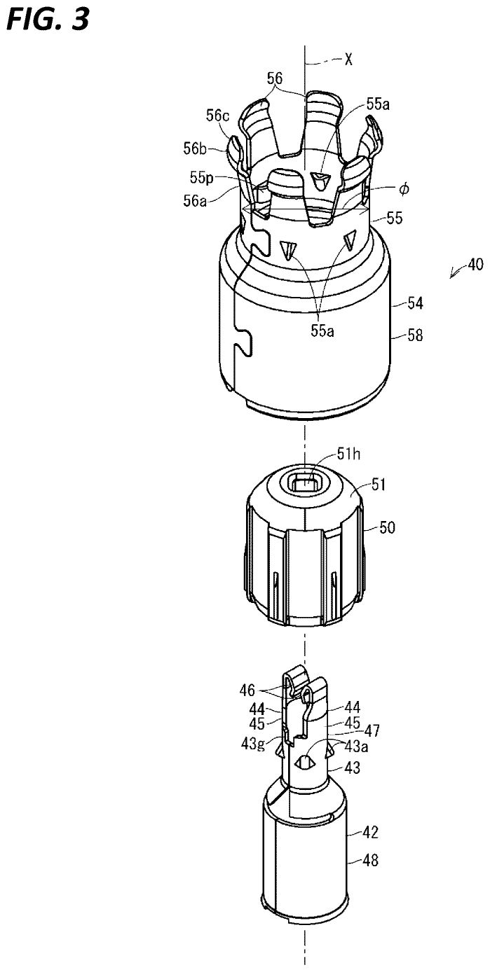

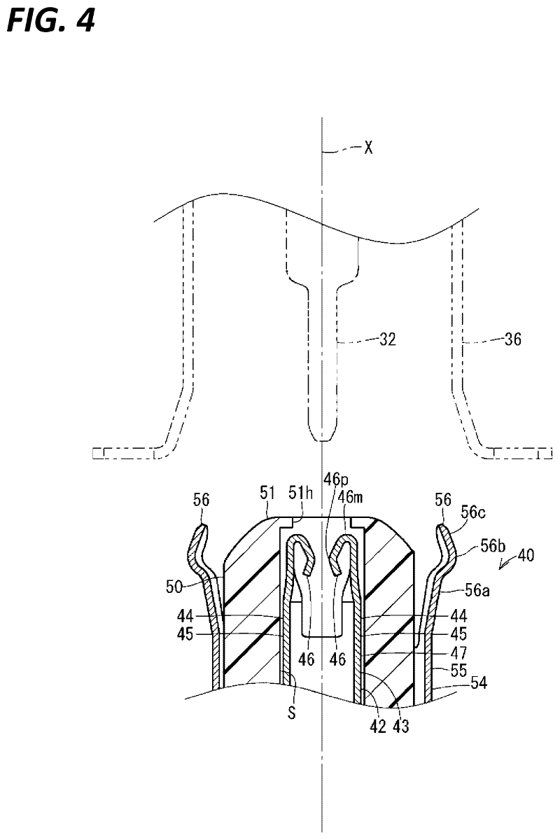

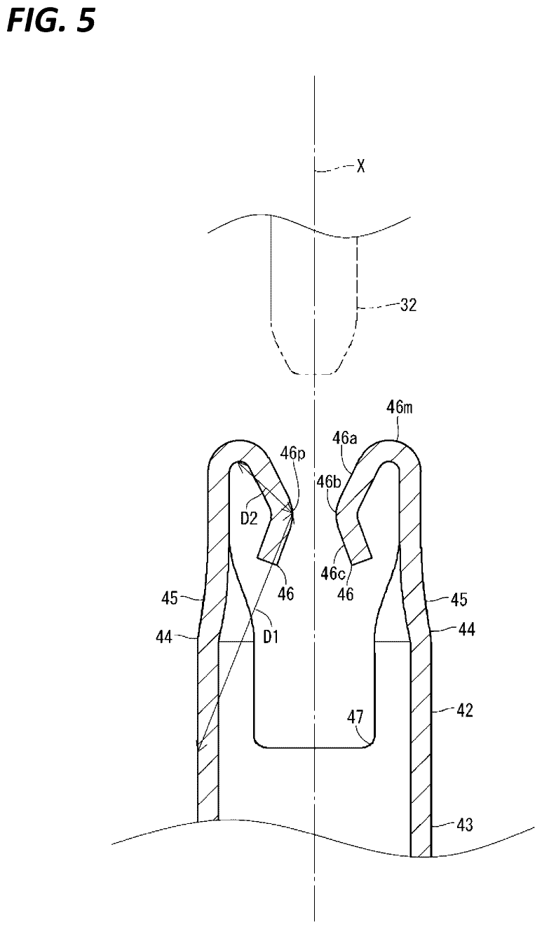

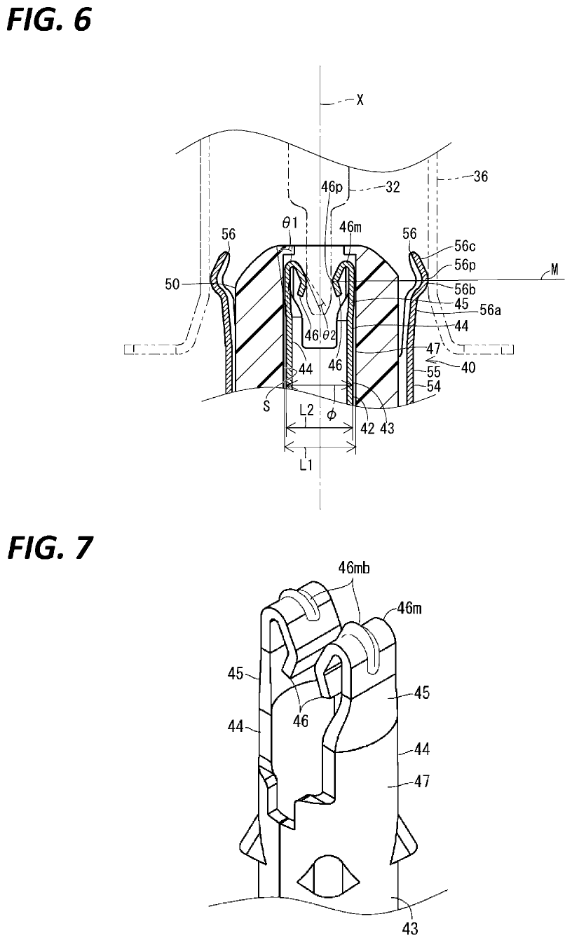

The relay coaxial connector 40 is more specifically described. FIG. 3 is an exploded perspective view showing the relay coaxial connector 40. FIG. 4 is a diagram showing a state before the external connection coaxial connector 30 is connected to the relay coaxial connector 40. FIG. 5 is a partial enlarged section of FIG. 4. FIG. 6 is a section showing a state where the external connection coaxial connector 30 is connected to the relay coaxial connector 40.

As shown in FIGS. 2 to 6, the relay coaxial connector 40 is provided with the movable side inner conductor 42, the movable side insulator 50 and the movable side outer conductor 54.

The movable side inner conductor 42 is an elongated electrically conductive member. In this embodiment, the movable side inner conductor 42 is formed by press-working a metal plate. More specifically, the movable side inner conductor 42 is provided with the tubular base portion 43, the plurality of resilient pieces 44 and an opposite connecting portion 48.

The tubular base portion 43 is formed into a tubular shape, more specifically a hollow cylindrical shape. One end of the tubular base portion 43 is facing toward the external connection inner conductor 32, and the other end thereof is facing toward the board side inner conductor 62.

Locking protrusions 43a may project on the tubular base portion 43. The locking protrusion 43a partially projects from an outer peripheral part of the tubular base portion 43. The locking protrusion 43a is shaped to gradually increase a projecting dimension from one end toward the other end of the tubular base portion 43. With the tubular base portion 43 inserted in the movable side insulator 50, the locking protrusions 43a are hooked to an inner peripheral part of the movable side insulator 50 and the movable side inner conductor 42 is held not to come out from the movable side insulator 50.

The tubular base portion 43 may include positioning recesses 43g partially recessed in a circumferential direction. The positioning recess 43g is a recess open on one end side, an inner peripheral side and an outer peripheral side of the tubular base portion 43.

In this embodiment, the positioning recesses 43g are located between the plurality of resilient pieces 44 in the circumferential direction of the one end of the tubular base portion 43. Positioning protrusions formed on an inner peripheral part of the movable side insulator 50 can be fit into these positioning recesses 43g. In this way, the rotation of the movable side inner conductor 42 with respect to the movable side insulator 50 is stopped. Further, a movement of the movable side inner conductor 42 to a tip side with respect to the movable side insulator 50 is restricted.

The plurality of resilient pieces 44 extend from the one end of the tubular base portion 43. Preferably, the plurality of resilient pieces 44 are located at equal intervals around a center axis X of the tubular base portion 43. In this embodiment, two resilient pieces 44 are facing each around the center axis X of the tubular base portion 43.

The external connection inner conductor 32 is inserted between the two resilient pieces 44 from the tip sides of the two resilient pieces 44. The external connection inner conductor 32 is sandwiched by the two resilient pieces 44, whereby the movable side inner conductor 42 is connected to the external connection inner conductor 32.

The opposite connecting portion 48 is connected to a side of the tubular base portion 43 opposite to the plurality of resilient pieces 44. The opposite connecting portion 48 is a part to be connected to the board side inner conductor 62. In this embodiment, the opposite connecting portion 48 is a tubular part, more specifically a tubular part thicker than the tubular base portion 43. For example, the board side inner conductor 62 is inserted and connected to the opposite connecting portion 48.

The movable side insulator 50 is made of resin or the like. A dielectric can be grasped as one type of insulator, and the movable side insulator 50 can be grasped as a dielectric. The movable side insulator 50 is, for example, a molded resin component.

The movable side insulator 50 is formed into a tubular shape capable of accommodating at least a part of the movable side inner conductor 42. In this embodiment, the movable side insulator 50 is formed into a hollow cylindrical shape and a cylindrical space S is formed inside. The tubular base portion 43 and the plurality of resilient pieces 44 of the movable side inner conductor 42 are accommodated in the cylindrical space S.

An inner diameter L1 of the cylindrical space S is larger than a diameter L2 of a virtual circle centered on the axis X and passing through the outer surfaces of the plurality of resilient pieces 44 (see FIG. 6). Thus, the plurality of resilient pieces 44 can be resiliently deformed inward and outward in the cylindrical space S, particularly resiliently deformed to spread more than in an initial state.

The movable side insulator 50 includes a head portion 51 located on an end part on the side of the external connection coaxial connector 30. The head portion 51 is formed with a hole 51h communicating with the cylindrical space S from outside. The hole 51h is thinner than the cylindrical space S and so formed that the external connection inner conductor 32 is insertable thereinto. That is, the cylindrical space S is narrowed by the head portion 51. The hole 51h is facing gaps between the tips of the plurality of resilient pieces 44 and closes around the tips sides of the plurality of resilient pieces 44. By restricting the position of the external connection inner conductor 32 by the hole 51h, the external connection inner conductor 32 is easily arranged between the plurality of resilient pieces 44.

The movable side insulator 50 is set to have such a length that the tubular base portion 43 and the plurality of resilient pieces 44 can be accommodated. The opposite connecting portion 48 projects outward from the movable side insulator 50.

The movable side outer conductor 54 is arranged on an outer peripheral side of the movable side insulator 50. The movable side outer conductor 54 is made of an electrically conductive material such as metal and surrounds the movable side insulator 50. The movable side outer conductor 54 is, for example, formed by press-working a metal plate.

The movable side outer conductor 54 is provided with an outer tubular base portion 55 and outer resilient pieces 55. In this embodiment, the movable side outer conductor 54 is further provided with an outer opposite connecting portion 58.

The outer tubular base portion 55 is formed into such a tubular shape that the movable side insulator 50 can be arranged inside. Locking protrusions 55a may project on the outer tubular base portion 55. The locking protrusion 55a partially projects from an inner peripheral part of the outer tubular base portion 55. The locking protrusion 55a is shaped to gradually reduce a projecting dimension from one end toward the other end of the outer tubular base portion 55. With the movable side insulator 50 inserted in the outer tubular base portion 55, the locking protrusions 55a are hooked to an outer peripheral part of the movable side insulator 50 and the movable side insulator 50 is held not to come out from the outer tubular base portion 55.

The outer tubular base portion 55 may include positioning protrusions 55p partially projecting inward in a circumferential direction (see FIG. 3). The rotation of the outer tubular base portion 55 with respect to the movable side insulator 50 may be stopped by fitting these positioning protrusions 55p into positioning recesses formed in the outer periphery of the movable side insulator 50. By fitting these positioning protrusions 55p into the positioning recesses, a movement of the outer tubular base portion 55 to the other end side with respect to the movable side insulator 50 may be restricted. By externally fitting the outer tubular base portion 55 to the movable side insulator 50, the outer tubular base portion 55 is arranged on the same axis as the tubular base portion 43.

The plurality of outer resilient pieces 56 extend from an opening edge on one end side of the outer tubular base portion 55. The plurality of outer resilient pieces 55 are arranged to surround one end part of the movable side insulator 50.

More specifically, the outer resilient piece 56 includes an inclined portion 56a, a bulging portion 56b and a tip guide portion 56c. The inclined portion 56a, the bulging portion 56b and the tip guide portion 56c are connected in this order from the opening on the one end side of the outer tubular base portion 55 toward one side of a center axis X of the outer tubular base portion 55.

The inclined portion 56a is inclined toward an outer peripheral side from the opening on the one end side of the outer tubular base portion 55 toward the tip of the outer resilient piece 56. The inclined portion 56a can be resiliently deformed in an in-out direction of the outer tubular base portion 55 mainly with a part connected to the outer tubular base portion 55 as a fulcrum. The inclined portion 56a is a part inclined outward toward the tip of a resilient piece body 45 between a resilient supporting portion 47 to be described later and the tip (here, folded portion 56m) of the resilient piece body 45.

The bulging portion 56b extends from the tip of the inclined portion 56a toward the one side of the center axis X while forming a curved surface convex outward. A part of the bulging portion 56b projecting furthest toward the outer peripheral side is an outer contact part 56p facing outward in a radial direction of the tubular base portion 43 and contacting the external connection outer conductor 36 (see FIG. 6).

The tip guide portion 56c is inclined toward an inner peripheral side from the tip of the bulging portion 56b toward the one side of the center axis X.

When the movable side outer conductor 54 is inserted into the external connection outer conductor 36, the tip guide portions 56c contact the opening edge of the external connection outer conductor 36, thereby guiding the outer resilient pieces 56 toward the inner peripheral side of the external connection outer conductor 36. With the movable side outer conductor 54 inserted in the external connection outer conductor 36, the inclined portions 56a are resiliently deformed toward the inner peripheral side. The outer contact parts 56p are resiliently pressed against the inner peripheral surface of the external connection outer conductor 36 by resilient forces of the inclined portions 56a to return to an original shape. In this way, the plurality of outer resilient pieces 56 contact the external connection outer conductor 36 from the inner peripheral side and the movable side outer conductor 54 and the external connection outer conductor 36 are connected. The outer opposite connecting portion 58 is inserted and connected to the board side outer conductor 80.

### Concerning Movable Side Inner Conductor

The movable side inner conductor 42 is more specifically described.

Each of the plurality of resilient pieces 44 of the movable side inner conductor 42 includes the resilient piece body 45 and a resilient contact piece 46.

The base end of the resilient piece body 45 is connected to one end of the tubular base portion 43. The resilient piece body 45 extends from the one end of the tubular base portion 43 toward one side in the axial direction X of the tubular base portion 43. In this embodiment, an intermediate part in an extension direction of the resilient piece body 45 is inclined toward the center axis X of the tubular base portion 43 toward a tip side. Further, a part of the resilient piece body 45 near the tip extends in parallel to the center axis X. Thus, in an initial state, a part further on the tip side than the intermediate part of the resilient piece body 45 is located more on the inner peripheral side than the extension of the outer peripheral surface of the tubular base portion 43.

The resilient contact piece 46 is an example of a contact portion projecting inward from the resilient piece body 45. In this embodiment, the resilient contact piece 46 is a resilient contact piece folded from the tip of the resilient piece body 45 toward the base end of the resilient piece body 45 via the folded portion 46m.

More specifically, the resilient contact piece 46 includes a base end side inclined portion 46a, a bent portion 46b and a tip side inclined portion 46c. The base end side inclined portion 46a, the bent portion 46b and the tip side inclined portion 46c are connected in this order from the base end side toward the tip side of the resilient contact piece 46.

The base end side inclined portion 46a is inclined toward the center axis X from the tip of the resilient piece body 45 toward the base end side of the resilient piece body 45. The tip side inclined portion 46c is connected to the tip of the base end side inclined portion 46a via the bent portion 46b. The bent portion 46b is a part bent to project toward the center axis X. The tip side inclined portion 46c is inclined away from the center axis X from the bent portion 46b toward the base end side of the resilient piece body 45.

If the entire resilient contact piece 46 is viewed, the bent portion 46b is located closest to the center axis X. Thus, if the external connection inner conductor 32 is inserted between the plurality of resilient pieces 44, the resilient contact pieces 46 contact the external connection inner conductor 32 with tops of the bent portions 46b as inner contact parts 46p (see FIG. 6).

In a state where the external connection inner conductor 32 is not connected, the tips of the resilient contact pieces 46 are preferably separated from the resilient piece bodies 45.

The base end of the resilient piece body 45 includes the resilient supporting portion 47 to be resiliently deformed to displace the tip of the resilient piece body 45 outward according to a displacement of the resilient contact piece 46 toward the outer peripheral side. The resilient supporting portion 47 is a part where the resilient piece body 45 is connected to the tubular base portion 43.

The resilient supporting portion 47 may be resiliently deformed to displace the tip of the resilient piece body 45 outward with the external connection inner conductor 32 inserted between the plurality of resilient pieces 44.

Note that the resilient deformation of the resilient supporting portion 47 with the external connection inner conductor 32 inserted between the plurality of resilient pieces 44 does not mean that the resilient contact piece 46 is not resiliently deformed with respect to the resilient piece body 45 at all.

However, with the external connection inner conductor 32 inserted between the plurality of resilient pieces 44, a resilient deformation amount θ1 of the resilient supporting portion 47 is preferably larger than a resilient deformation amount θ2 of the folded portion 46m. For example, the resilient deformation amount θ1 of the resilient supporting portion 47 may be grasped as an angle change amount of the resilient piece body 45 after the insertion of the external connection inner conductor 32 from an initial angle of the resilient piece body 45 (see FIG. 6). Further, the resilient deformation amount θ2 of the folded portion 46m may be grasped as an angle change amount of the base end side inclined portion 46a after the insertion of the external connection inner conductor 32 from an initial angle of the base end side inclined portion 46a (see FIG. 6).

If the resilient deformation amount θ1 of the resilient supporting portion 47 is larger than the resilient deformation amount θ2 of the folded portion 46m, the tip and the intermediate part of the resilient piece body 45 are easily displaced in a direction separating from the center axis X by a displacement of the inner contact part 46p in the direction separating from the center axis X caused by the insertion of the external connection inner conductor 32.

By inserting the external connection inner conductor 32 into the movable side inner conductor 42, a part on the tip side of the resilient piece body 45 is displaced outward. At this time, a displacement amount of the resilient piece body 45 can be adjusted by a projecting amount of the resilient contact piece 46 from the resilient piece body 45. Accordingly, by adjusting the projecting amount of the resilient contact piece 46, the position of the resilient piece body 45 in the connected state can be adjusted. By adjusting the position of the resilient piece body 45, an interval between the resilient piece body 45 and the movable side outer conductor 54 in the connected state can be adjusted. In the connected state, the resilient contact piece 46 can be pressed against the external connection inner conductor 32, utilizing a resilient restoring force of the resilient supporting portion 47.

For example, in the connected state, the resilient piece body 45 can be set in a state inclined outward toward the tip side (see FIG. 6). As described above, the outer resilient piece 56 is assumed to be inclined outward for resilient contact with the external connection outer conductor 36. In this case, a state of the resilient piece body 45 and the inclined portion 56a can be approximated to a parallel state in the connected state. In this way, a distance between the resilient piece body 45 and the inclined portion 56a is easily kept as constant as possible in a direction along the center axis X. If the distance between the resilient piece body 45 and the inclined portion 56a can be kept as constant as possible, communication performance dependent on an interval between the movable side inner conductor 42 and the movable side outer conductor 54 is easily kept as desired.

To make the resilient deformation amount θ1 of the resilient supporting portion 47 larger than the resilient deformation amount 02 of the folded portion 46m, a distance between the inner contact part 46p of the resilient contact piece 46 and the resilient supporting portion 47 may be made greater than a distance D2 between the inner contact part 46p and the folded portion 46m (see FIG. 5). If the resilient supporting portion 47 is more separated from the inner contact part 46p to be displaced during the insertion of the external connection inner conductor 32 than the folded portion 46m, a larger moment is applied to the resilient supporting portion 47 than to the folded portion 46m. Thus, the resilient deformation amount 01 of the resilient supporting portion 47 is easily made larger than the resilient deformation amount θ2 of the folded portion 46m.

A configuration for making the resilient deformation amount θ1 of the resilient supporting portion 47 larger than the resilient deformation amount θ2 of the folded portion 46m is not limited to the above example. For example, as shown in FIG. 7, the folded portion 46m may be formed with a rib 46mb for reinforcement to suppress the resilient deformation thereof. Besides, the folded portion 46m may be made thicker than the resilient supporting portion 47.

Further, the resilient supporting portion 47 may have resilience to keep the tip of the resilient contact piece 46 in a state separated from the resilient piece body 45 with the external connection inner conductor 32 inserted and connected to the movable side inner conductor 42. The resilience of the resilient supporting portion 47 can be adjusted by setting a width, a thickness or the like of the base end of the resilient supporting portion 47 according to a displacement amount or the like of the inner contact part 46p caused by the insertion of the external connection inner conductor 32.

In the axial direction X of the tubular base portion 43, the inner contact part 46p of the resilient piece 44 and the outer contact part 56P of the outer resilient piece 56 are preferably set at the same position (see a line M of FIG. 6). Here, that the inner contact part 46p and the outer contact part 56P are set at the same position in the axial direction X includes a case where the parts 46p, 56p are located within a distance range of ±5% of an outer diameter φ of the tubular base portion 43.

If the inner and outer contact parts 46p, 56P are largely shifted in the axial direction X, there is a possibility that the inner and outer contact parts 46p, 56P largely deviate in directions separating from each other if the relay coaxial connector 40 is largely inclined with respect to the external connection coaxial connector 30.

If the inner and outer contact parts 46p, 56P are set at the same position in the axial direction X, the inner and outer contact parts 46p, 56P hardly largely deviate even if the relay coaxial connector 40 is largely inclined with respect to the external connection coaxial connector 30. Thus, the movable side inner conductor 42 and the movable side outer conductor 54 are easily kept in a coaxial positional relationship and desired communication performance is easily maintained.

### Effects, Etc.

According to the relay coaxial connector 40 configured as described above, if the external connection inner conductor 32 is inserted and connected to the movable side inner conductor 42, the external connection inner conductor 32 contacts the respective resilient contact pieces 46 of the plurality of resilient pieces 44. If the inner contact part 46p of each resilient piece 44 is displaced outward in this way, the resilient supporting portion 47 located on the base end of the resilient piece body 45 is resiliently deformed and the tip of the resilient piece body 45 is displaced outward. Thus, the tip of the resilient piece body 45 can be displaced outward and the interval between the movable side inner conductor 42 and the movable side outer conductor 54 is easily adjusted according to the thickness of the external connection inner conductor 32 and the projecting amount of the resilient contact piece 46.

For example, due to the restriction such as the cost, size or shape of the device 10, the size of the movable side outer conductor 54 or the movable side insulator 50, a dielectric constant of the movable side insulator 50 or the like may be restricted. In such a case, an outer diameter of the movable side inner conductor 42 can be adjusted according to that of the external connection inner conductor 32. The interval between the movable side inner conductor 42 and the movable side outer conductor 54 can be adjusted and a characteristic impedance near a contact point can be adjusted by adjusting the outer diameter of the movable side inner conductor 42.

Further, since the resilient contact piece 46 is folded from the tip of the resilient piece body 45 via the folded portion 46m, the resilient contact piece 46 serving as a contact portion projecting inward from the resilient piece body 45 can be easily formed.

Further, the tip of the resilient contact piece 46 is separated from the resilient piece body 45. The tip of the resilient piece body 45 is preferably kept separated from the resilient piece body 45 even in the inserted state of the external connection inner conductor 32.

If the tip of the resilient contact piece 46 is in contact with the resilient piece body 45, a signal transmission path from the inner contact part 46p of the resilient contact piece 46 to the resilient piece body 45 by way of the tip of the resilient contact piece 46 is possibly configured. In this case, a desired characteristic impedance based on the overall shape of the resilient piece body 45 is possibly not obtained.

If the tip of the resilient contact piece 46 is separated from the resilient piece body 45, a signal transmission path from the inner contact part 46p of the resilient contact piece 46 by way of the folded portion 46m and the resilient piece body 45 is configured with the external connection inner conductor 32 inserted in the movable side inner conductor 42. In this way, the desired characteristic impedance noise designed based on the overall shape of the resilient piece body 45 is obtained.

Further, the resilient deformation amount θ1 of the resilient supporting portion 47 is larger than the resilient deformation amount θ2 of the folded portion 46m in the inserted and connected state of the external connection inner conductor 32. Thus, the resilient piece body 45 can be largely displaced outward and the interval between the movable side inner conductor 42 and the movable side outer conductor 54 is easily adjusted according to the thickness of the external connection inner conductor 32 and the projecting amount of the resilient contact piece 46.

To make the resilient deformation amount θ1 of the resilient supporting portion 47 larger than the resilient deformation amount θ2 of the folded portion 46m, a distance D1 between the inner contact part 46p and the resilient supporting portion 47 may be set to be greater than a distance D2 between the inner contact part 46p and the folded portion 46m. In this way, a larger moment acts on the resilient supporting portion 47 than on the folded portion 46m by a displacement of the inner contact part 46p, and the resilient supporting portion 47 is largely resiliently deformed. Thus, the tip of a resilient piece body can be more largely displaced outward and an interval between the inner conductor and the outer conductor is easily adjusted according to a thickness of a mating inner conductor and a projecting amount of a contact portion.

The configuration for making the resilient deformation amount θ1 of the resilient supporting portion 47 larger than the resilient deformation amount θ2 of the folded portion 46m is also realized by the setting of the shapes of the resilient supporting portion 47 and the folded portion 46m. For example, the folded portion 46m may be formed with the rib 46mb to suppress the resilient deformation thereof.

Further, the movable side outer conductor 54 includes the inclined portion 56a inclined outward toward the tip of the resilient piece body 45 between the resilient supporting portion 47 and the resilient piece body 45 along the axial direction X of the tubular base portion 43. As described above, the resilient piece body 45 is thought to be inclined outward toward the tip with the tip of the resilient piece body 45 displaced outward by the insertion of the external connection inner conductor 32. In this case, an interval change between the resilient piece body 45 and the movable side outer conductor 54 can be suppressed in a direction along the axial direction X, whereby noise design is facilitated.

Further, in the axial direction X of the tubular base portion 43, the inner contact part 46p and the outer resilient piece 56 are set at the same position. Thus, even if the relay coaxial connector 40 is inclined with respect to the external connection coaxial connector 30, the inner contact parts 46p and the outer resilient pieces 56 are easily arranged around the same axis. In this way, even if the relay coaxial connector 40 is inclined, the degradation of communication performance is suppressed.

Note that an example in which the contact portion is the resilient contact piece 46 folded from the tip of the resilient piece body has been described in this embodiment. It is not essential that the contact portion is the folded resilient contact piece. The contact portion may be a part formed by causing an intermediate part of the resilient contact piece to partially project inward by press working or the like. The contact portion may be a solid projection formed by machining, welding or the like.

Note that the respective configurations described in the above embodiment and each modification can be approximately combined without contradicting each other.

### LIST OF REFERENCE NUMERALS

10 device
12 case
13 first case
14 second case
15 bottom portion
16 holding tube portion
17 holding/partitioning portion
17h holding hole
20 electrical component
21 circuit board
22 imaging element
30 external connection coaxial connector
32 external connection inner conductor (mating inner conductor)
34 external connection insulator
36 external connection outer conductor (mating outer conductor)
40 relay coaxial connector (coaxial connector)
42 movable side inner conductor (inner conductor)
43 tubular base portion
43a locking protrusion
43g positioning recess
44 resilient piece
45 resilient piece body
46 resilient contact piece (contact portion)
46a base end side inclined portion
46b bent portion
46c tip side inclined portion
46m folded portion
46mb rib
46p inner contact part
47 resilient supporting portion
48 opposite connecting portion
50 movable side insulator (insulator)
51 head portion
51h hole
54 movable side outer conductor (outer conductor)
55 outer tubular base portion
55a locking protrusion
55p positioning protrusion
56 outer resilient piece
56P outer contact part
56a inclined portion
56b bulging portion
56c tip guide portion
56p outer contact part
58 outer opposite connecting portion
60 board side coaxial connector
62 board side inner conductor
70 board side insulator
80 board side outer conductor
D1, D2 distance
L1 inner diameter
M line
S cylindrical space
X axial direction (center axis)
θ1, θ2 resilient deformation amount
φ outer diameter

1. A coaxial connector, comprising:
an inner conductor, a pin-like mating inner conductor being inserted and connected to the inner conductor, the inner conductor including a tubular base portion and a plurality of resilient pieces extending from one end of the tubular base portion;
an insulator surrounding the inner conductor; and
an outer conductor surrounding the insulator,
each of the plurality of resilient pieces including a resilient piece body extending from one end of the tubular base portion toward one side in an axial direction of the tubular base portion and a contact portion projecting inward from the resilient piece body, and
a base end of the resilient piece body including a resilient supporting portion to be resiliently deformed to displace a tip of the resilient piece body outward according to an outward displacement of the contact portion.

2. The coaxial connector of claim 1, wherein the contact portion is a resilient contact piece folded from the tip of the resilient piece body toward the base end of the resilient piece body via a folded portion.

3. The coaxial connector of claim 2, wherein a tip of the resilient contact piece is separated from the resilient piece body.

4. The coaxial connector of claim 3, wherein the resilient supporting portion has resilience to keep the tip of the resilient contact piece in a state separated from the resilient piece body with the mating inner conductor inserted and connected to the inner conductor.

5. The coaxial connector of claim 2, wherein a resilient deformation amount of the resilient supporting portion is larger than a resilient deformation amount of the folded portion with the mating inner conductor inserted and connected to the inner conductor.

6. The coaxial connector of claim 2, wherein a distance between an inner contact part of the resilient contact piece with the mating inner conductor and the resilient supporting portion is greater than a distance between the inner contact part and the folded portion.

7. The coaxial connector of claim 2, wherein the folded portion is formed with a rib for suppressing resilient deformation of the folded portion.

8. The coaxial connector of claim 1, wherein the outer conductor includes an inclined portion inclined outward toward the tip of the resilient piece body between the resilient supporting portion and the tip of the resilient piece body along the axial direction of the tubular base portion.

9. The coaxial connector of claim 1, wherein an inner contact part of the contact portion with the mating inner conductor and an outer contact part of the outer conductor with a mating outer conductor are set at the same position in the axial direction of the tubular base portion.
